(19) United States
(12) Patent Application Publication
(10) Pub. No.: US 2026/0334734 A1
(43) Pub. Date: Oct. 29, 2026

(54) LIQUID SEASONING INJECTOR APPARATUS AND METHOD OF USE

(71) Applicant: Donald Scott Rogers, Lafayette, LA (US)

(72) Inventor: Donald Scott Rogers, Lafayette, LA (US)

(21) Appl. No.: 19/193,198

(22) Filed: Apr. 29, 2025

(51) Int. Cl. A47J 43/16; A23L 13/75

(52) U.S. Cl. CPC A47J 43/16; A23L 13/75

(57) ABSTRACT

A liquid marinade and seasoning injector having a collapsible container containing a quantity of liquid seasoning, a sealable container opening, and an injection needle assembly threadedly attached at the container opening. The container opening may have a cap with a puncturable seal, and the injection needle assembly may have a trocar cannula whereby the puncturable seal may be punctured. Heat shrink wrap may be used to removably attach the injection needle assembly to the collapsible container.

### FIELD OF INVENTION

This invention relates to the field of cooking and food seasoning methods and, more particularly, to a liquid seasoning injection apparatus and method for facilitating the use of injectable seasonings and marinades.

### BACKGROUND OF INVENTION

The injection of liquid seasonings and marinades into meats for enhancing flavors is well known. Most injection techniques utilize a seasoning syringe and needle to draw a liquid seasoning from a bottle or jar containing a liquid emulsion of oil and a desired seasoning. Such syringes are comprised of a plunger fitted into a cylindrical barrel through which a hollow injection needle is attached. When such seasoning syringes are utilized with more than one liquid seasoning or marinade type, the risk of contamination of the seasoning products being used is enhanced.

Injectable marinades not sold as single use lead to both waste and an increased health risk. Contamination is a risk both to the marinade and the needle. Risk to the marinade contamination is highest if the syringe is filled multiple times during use without washing the syringe. In this case, contaminants from the raw meat are introduced to the marinade. General guidelines are to transfer marinade to a different container for use or discard remaining marinade. Risk to the needle is due to needle construction as needles may have cavities that are very difficult to clean. This poses a risk during subsequent use of the needle.

Use of such seasoning syringes can be quite messy and often require extra time for cleanup after the seasoning is completed. Further, the pointed needle utilized in such syringes increases the risk of puncture wounds and other injuries during clean up imposing a corresponding chance of wound infection. These disadvantages often discourage the use of such seasoning syringes.

Consequently, a need exists for an injectable seasoning apparatus and method that will simplify and encourage the use of injectable liquid seasonings and marinades, eliminate or minimize cleanup time, and minimize risks of injury to users.

### SUMMARY OF THE INVENTION

The present invention is intended to provides a single use liquid seasoning injection apparatus and method for facilitating the use of injectable seasonings and marinades in order to reduce or eliminate the aforementioned problems and inefficiencies experience when injecting liquid seasonings and marinades.

In one embodiment, the liquid seasoning injection apparatus is comprised of a compressible container having a quantity of a desired liquid seasoning such as a seasoning or marinade, a seasoning port for removing liquid from the compressible container, and a container cap covering the seasoning port. The container cap is configured to readily receive and secure a threaded injection needle assembly. The compressible container may be a compressible bottle, bag, tube, jar, or similar device comprised of a compressible material such as a soft plastic or other soft polymer material.

The injection needle assembly has in fluid communication, a pointed trocar tube, a tubular exterior threaded needle hub, and a tubular needle having a cannula shaft, a pointed tip, and a fluid needle port. A flange extending radially from the needle hub may be provided to facilitate insertion of the trocar tube. A removable protective shield or cover may be provided for the needle of the injection needle assembly for safety or for later storage of the liquid contents.

The container cap has interior threads configured to threadedly engage the exterior threads of the injection needle hub and an interior lining or seal. The interior lining or seal of the container cap is configured to be punctured by the pointed trocar tube to allow the sealed liquid contents of the compressible container to flow into and through the cannula shaft and the fluid needle port of the needle tip of the injection needle assembly.

The interior lining or seal may also be a seal or lining covering, or included within, the seasoning port of the compressible container rather than a component of the container cap.

The interior lining or seal in the container cap may be a thin penetrable lining of paper, plastic, or other polymer material.

The injection needle assembly may be removably attached to the compressible container by heat shrink plastic wrap or some other suitable attachment mechanism for convenience in packaging.

In the second embodiment, the liquid seasoning injection apparatus is comprised of a compressible container having a quantity of a desired liquid contents such as a seasoning or marinade, a seasoning port for removing liquid from the compressible container, an injection needle assembly comprised of a first attachable and detachable container cap having an injection needle, and a second attachable and detachable container cap. The injection needle of the injection needle assembly of the second embodiment of the liquid seasoning injection apparatus has a cannula shaft, a pointed tip, and a fluid needle port. The second container cap has no injection needle and it covers the seasoning port of the compressible container until it is removed from the compressible container and replaced with the first container cap of the injection need assembly for injection of liquid seasoning or marinade from the compressible container.

The compressible container may be a compressible bottle, bag, tube, jar, or similar device comprised of a compressible material such as a soft plastic or other soft polymer material.

The second container cap with the injection needle may be removably attached to the compressible container by heat shrink plastic wrap or some other suitable attachment mechanism for convenience in packaging. A removable protective shield or cover may be provided for the needle of the second container cap for safety or for later storage of the liquid contents. It is thought that the first and second container caps will be threadedly attachable and detachable from the compressible container.

To use the liquid seasoning injection apparatus of the first embodiment of the present invention, the injection needle assembly is removed from the compressible container by cutting or tearing the heat shrink plastic wrap around the container. The injection needle assembly is then attached to the compressible container by threadedly engaging the exterior threads on the injection needle hub with the interior threads of the container cap so that the trocar tube of the injection needle assembly will puncture the interior lining or seal on the container cap. Doing so will allow the liquid contents of the compressible container to flow through the cannula shaft and the fluid needle port of the injection needle. The tip of the injection needle is then inserted into a food product to the seasoned or marinated so that the liquid contents of the compressible container will be injected into the food product through the fluid needle port of the injection needle. The process may be repeated as desired. Compressing the container will facilitate the flow of the liquid contents of the compressible container to the food product. The food products may be poultry, pork, beef, or game.

To use the second embodiment of the liquid seasoning injection apparatus of the present invention, the second container cap with the attached injection needle is removed from the compressible container by cutting or tearing the heat shrink plastic wrap around the container. The first container cap is removed from the compressible container and the second container cap is then attached to the compressible container. The injection process for injecting a food product with the liquid contents of the compressible container as described above for the first embodiment is then utilized. The needle shield or cover may be placed on the injection needle of the second container cap for safety or for later storage of the liquid contents.

### BRIEF DESCRIPTION OF DRAWINGS

FIG. 1 is a schematic view of the first embodiment of the liquid seasoning injection apparatus of the present invention.

FIG. 2 is a side view of the injection needle assembly of the first embodiment of the liquid seasoning injection apparatus shown in FIG. 1.

FIG. 3 is a top view of the injection needle assembly of the first embodiment of the liquid seasoning injection apparatus shown in FIG. 1.

FIG. 4 is a schematic cross-section view of the injection needle assembly and the container cap cut along lines 4-4 of FIG. 6.

FIG. 5 is a schematic cross-section view illustrating insertion of the first embodiment of the injection needle assembly into the container cap and through the cap lining of the first embodiment of the liquid seasoning injection apparatus shown in FIG. 1.

FIG. 6 is a schematic view of the assembly steps of the first embodiment of the liquid seasoning injection apparatus shown in FIG. 1.

FIG. 7 is a schematic view of the second embodiment of the liquid seasoning injection apparatus of the present invention.

FIG. 8 is a schematic view of the assembly steps for use of the second embodiment of the liquid seasoning injection apparatus shown in FIG. 7.

FIG. 9 is a representative view showing the use of the first embodiment of the liquid seasoning injection apparatus shown in FIG. 1.

FIG. 10 is a representative view showing the use of the second embodiment of the liquid seasoning injection apparatus shown in FIG. 7.

FIG. 11 is a schematic cross-section view illustrating insertion of the injection needle assembly into the container cap and the container neck and through the neck lining or seal of the first embodiment of the liquid seasoning injection apparatus shown in FIG. 1.

FIG. 12 is a schematic partial cross-section view showing attachment of the second container cap of the second embodiment of the injection needle assembly shown in FIG. 7 onto container neck.

### DETAILED DESCRIPTION OF THE INVENTION

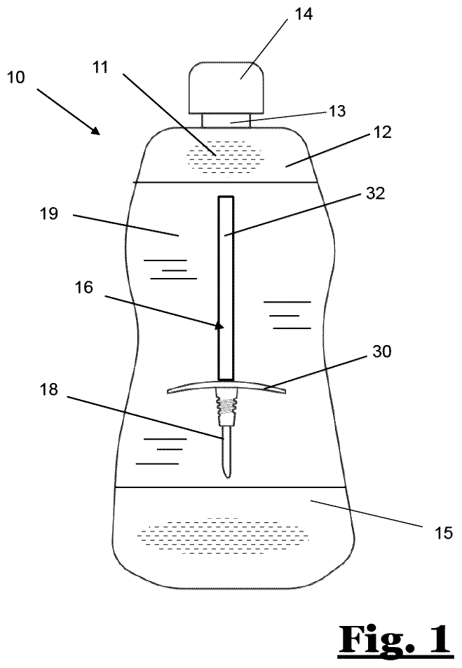

FIG. 1-6 show the first embodiment of the liquid seasoning injection apparatus (10) of the present invention. The liquid seasoning injection apparatus (10) is comprised of a compressible container (12) configured for holding a quantity of a desired liquid contents (11) such as a seasoning or marinade, a container neck (33) creating a container seasoning port (13), and a container cap (14) over the container seasoning port (13), the container cap (14) being configured to readily receive and secure a threaded injection needle assembly (16). The compressible container (12) has collapsible outer surfaces (15) and may be a compressible bottle, bag, tube, jar, or similar device comprised of a compressible material such as a soft plastic or other soft polymer material.

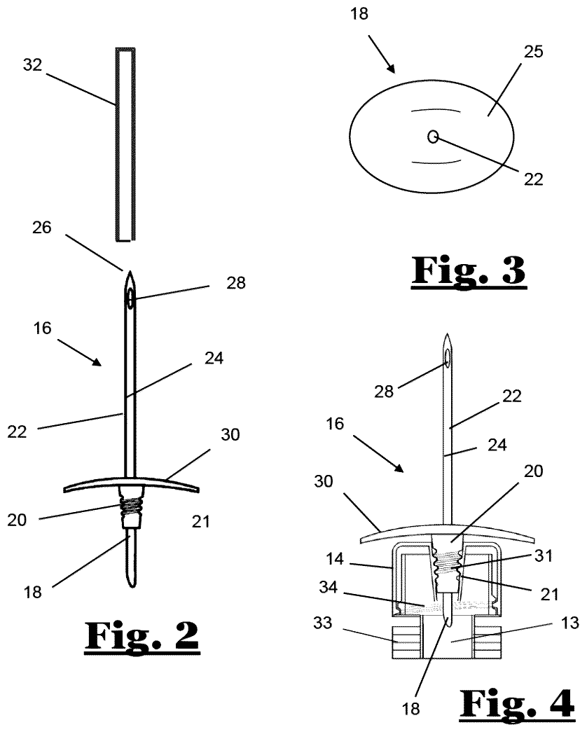

Referring to FIG. 2, the injection needle assembly (16) has in fluid communication, a pointed trocar tube (18), a tubular needle hub (20) having exterior threads (21), and a tubular needle (22). The injection needle assembly (16), including the needle and trocar, may be comprised of any suitable material and its components may be made entirely of plastic, or entirely of metal alloys such as stainless steel or aluminum alloys, or it may be made as a combination of metal alloys and plastics.

Tubular needle (22) is comprised of a cannula shaft (24), a pointed tip (26), and a fluid needle port (28). A flange (30) extending radially from the needle hub (20), preferably as shown in FIG. 3, may be provided to facilitate engagement of the injection needle assembly (16), particularly the trocar tube (18) with the cap (14). The flange (30) also facilitates ergonomics during use by providing a feature to push against while penetrating a food product such as meat with the needle (22). A removable protective shield or cover (32) may be provided for the needle (22) for safety or for later storage of the contents of the compressible container (12).

FIG. 4 shows the combination of the container cap (14) and the injection needle assembly (16). Container cap (14) has interior threads (31) configured to threadedly engage the exterior threads (21) of the injection needle hub (20). The container cap (14) has an interior lining or seal (34) comprised of impermeably paper, plastic, or other polymer to seal the container seasoning port (13) of the compressible container (12). The interior lining or seal (34) is configured to be punctured by the pointed trocar tube (18) when the injection needle assembly (16) is threadedly engaged with the container cap (14) by rotation of the injection needle assembly (16) as shown in FIG. 5. The lining or seal (34) may also be positioned within the neck (33) to seal the container seasoning port (13) as shown in FIG. 11 rather than within the cap (14). In such a case, trocar tube (18) will be of sufficient length to extend into the neck (33) in order to puncture the lining or seal (34) covering the container seasoning port (13).

The punctured lining or seal (34) allows the sealed liquid contents (11) of the compressible container (12) to flow into and through the cannula shaft (24) of needle (22) and through the fluid needle port (28) of the needle (22). The injection needle assembly (16) may preferrable be removably attached to the compressible container (12) by heat shrink plastic wrap (19) for convenience in packaging and safety. Some other suitable mechanism for releasable attachment of the injection needle assembly (16) to the compressible container (12) may also be utilized such as by gluing the injection needle assembly (16) to the compressible container (12) or attaching a separate container or box holding the injection needle assembly (16) to the compressible container (12) may also be utilized.

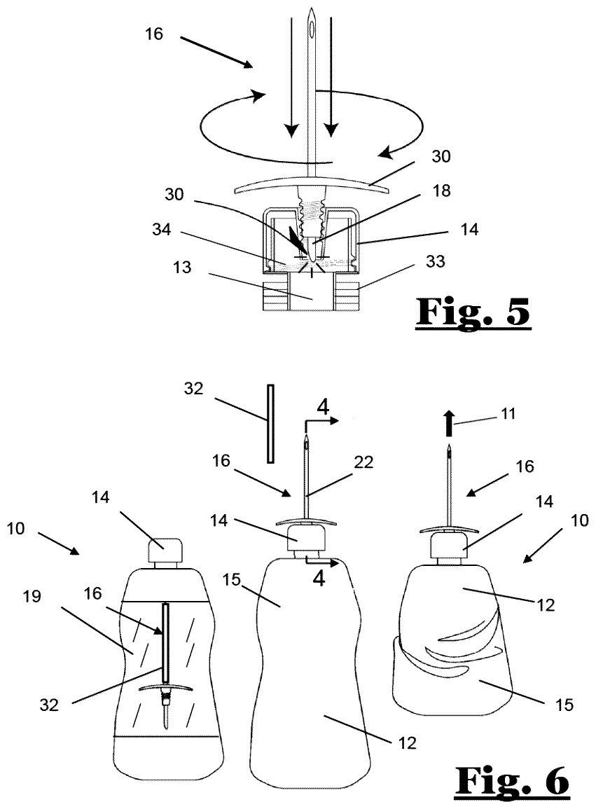

FIG. 6, a schematic view of the assembly steps of the liquid seasoning injection apparatus shown in FIG. 1, shows the steps of providing the injection needle assembly (16) and a compressible container (12) containing a quantity of a desired seasoning or marinade (11). Sealing the compressible container (12) with a container cap (14). Attaching the injection needle assembly (16) to the sealed compressible container (12) by shrink wrap (19) or another suitable method. Then, removing the shrink wrap from the container to free the injection needle assembly (16). Then, attaching the needle assembly (16) to the container cap (14) by pushing the needle assembly (16) onto the container cap (14) and twisting or turning the flange (30) and thereby puncturing the lining or seal (34) with the pointed trocar tube (18) as shown in FIG. 5.

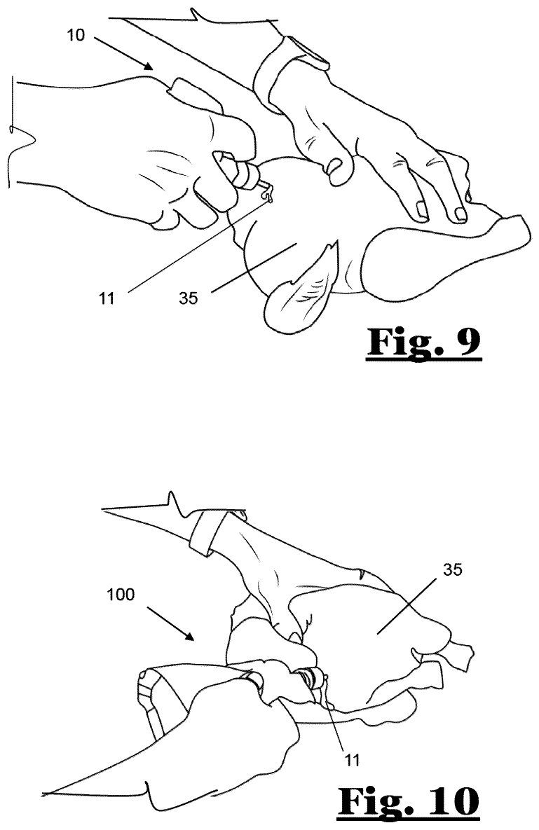

When the needle assembly (16) is so attached to the container cap (16), the protective cover (32) may then be removed from the injection needle (22) and seasoning may be accomplished by inserting the needle (22) of the injection needle assembly (16) into a food product (35) at a desired location and then compressing the sides (15) of the compressible container (12) as shown in FIG. 6 and in FIG. 9. Compressing the sides of the compressible container (12) will introduce the seasoning or marinade (11) from the compressible container (12) through the needle (22) and through the needle port (28) into the food product (35). When the injection needle (22) is removed from the food product (35), the protective cover (32) may then be replaced over the injection needle (22) as a guard against puncture injuries.

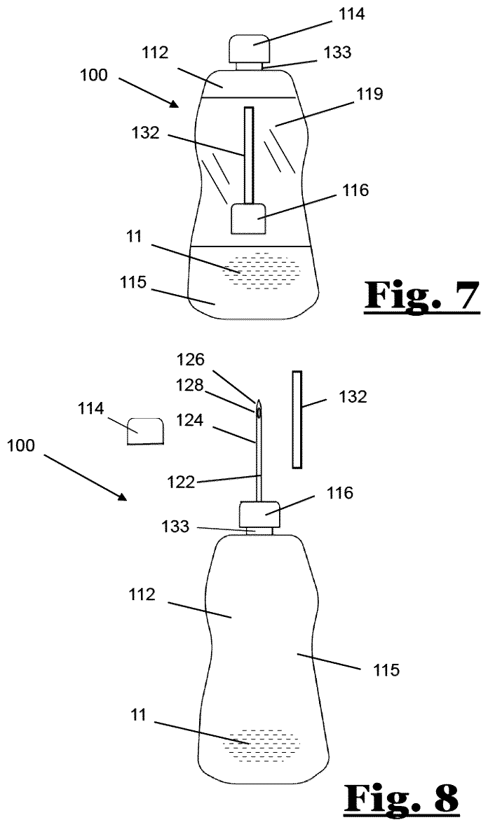

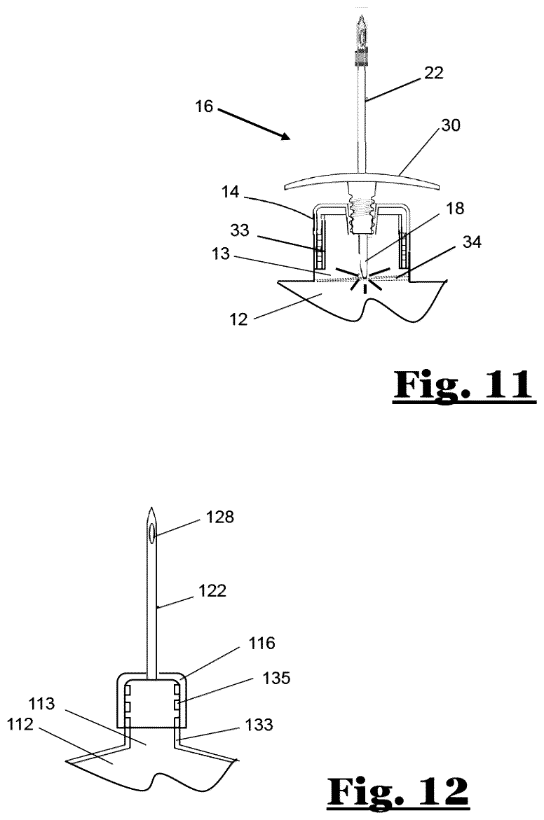

FIG. 7 shows a second embodiment of the liquid seasoning injection apparatus (100) of the present invention. In the second embodiment, the liquid seasoning injection apparatus (100) is comprised of a compressible container (112) having a quantity of a desired liquid contents (11) such as a seasoning or marinade. Compressible container (12) has a container neck (133) configured to create a container seasoning port (113), shown in FIG. 12. The liquid seasoning injection apparatus (100) is also comprised of a first container cap (114) configured to be attachable and detachable from the container neck (133) for sealing and unsealing the compressible container (112) and a second attachable and detachable container cap (116) having an attached injection needle (122). The compressible container (112) has collapsible outer surfaces (115) and may be a compressible bottle, bag, tube, jar, or similar device comprised of a compressible material such as a soft plastic or other soft polymer material.

The injection needle (122) of the second container cap (116), shown in more detail in FIG. 8, has a cannula shaft (124), a pointed tip (126), and a fluid needle port (128). The second container cap (116) with the injection needle (122) is interchangeable with the first container cap (114) and is used to replace the first container cap for injecting seasoning or marinade from the container (112). The second container cap (116) with the injection needle (122) may be removably attached to the compressible container (112) by removable heat shrink plastic wrap (119) or some other suitable attachment mechanism for convenience in packaging. A removable protective shield or cover (132) may be provided for the injection needle (122) of the second container cap (116) as a guard against unintended punctures.

Preferably, the first container cap (114) and second container cap (116) will be threadedly attached to the container neck (133) of container (112) such as by attachment threads (135) on the container caps and the container neck (133) as shown in FIG. 12. However, other suitable releasably attachment mechanisms may be utilized for attachment of the first container cap (114) or the second container cap (116) to the container (112) such as by use of a push and pull attachment mechanism.

FIG. 8 shows the liquid seasoning injection apparatus (100) shown in FIG. 7 and the steps for its assembly for use. The steps include providing the compressible container (112) containing a quantity of a desired seasoning or marinade (11) sealed by cap (114). Then removing the second container cap (114) with the attached injection needle (122) from the compressible container (112) by first removing the heat shrink plastic wrap (119) from around the container. Then attaching the second container cap (116) with the attached injection needle (122) to the container neck (133). Then, removing the needle shield or cover (132) from the injection needle (122) of the second container cap (116). Then, inserting the injection needle (122) into food product (35) at a desired location and squeezing or compressing the sides (115) of the compressible container (112) as shown in FIG. 10. Compressing the sides of compressible container (112) introduces seasoning or marinade (11) from the compressible container (112) through the injection needle (122) and through fluid needle port (128) into the food product (35). When the injection needle (122) is removed from the food product (35), the protective cover (132) may again be placed over the injection needle (122) as a safety measure to prevent punctures.

Because it is thought that the liquid seasoning injection apparatus (10) and the liquid seasoning injection apparatus (100) of the present invention will be single use devices, the risk of contamination of the contained seasoning or marinade and the food products with which they will be utilized will be minimized. It is also thought that providing seasonings or marinades in such single use containers will enhance their convenience and safety, and thus foster the use of seasonings and marinades in household kitchens.

It is also thought that the embodiments of the invention presented herein, and their attendant advantages will be understood from the foregoing description and that it will be apparent that various changes may be made in the form, construction, and arrangement of the parts of the embodiments without departing from the spirit and scope of the invention or sacrificing its material advantages. The form and construction described and illustrated herein are merely example embodiments of the invention.

I claim:

1. A liquid marinade and seasoning injector assembly comprising:
(a) a compressible container having a compressible outer surface and a container neck configured to create a sealable container port;
(b) a quantity of liquid within said compressible container;
(c) a container port seal; and
(d) an injection needle configured for fluid communication with said quantity of liquid within said compressible container.

2. The liquid marinade and seasoning injector assembly recited in claim 1, wherein said injection needle assembly is removably attachable to said compressible outer surface of said compressible container.

3. The liquid marinade and seasoning injector assembly recited in claim 2, wherein said container port seal is a first container cap attachable and detachable from said container neck whereby said container port is sealed.

4. The liquid marinade and seasoning injector assembly recited in claim 3, wherein said injection needle includes a second container cap attachable and detachable from said container neck.

5. The liquid marinade and seasoning injector assembly recited in claim 1, wherein said container port seal is comprised of a container cap having a puncturable impermeable lining whereby said container port is sealed.

6. The liquid marinade and seasoning injector assembly recited in claim 5, wherein said injection needle is further comprised of a trocar cannula in fluid communication with said injection needle.

7. The liquid marinade and seasoning injector assembly recited in claim 6, further comprising a radially extending flange positioned around said injection needle and said trocar cannula.

8. The liquid marinade and seasoning injector assembly recited in claim 7, wherein said trocar cannula is configured to puncture said a puncturable impermeable lining of said container cap.

9. The liquid marinade and seasoning injector assembly recited in claim 8 further comprising a threaded hub supporting said radially extending flange, said injection needle, and said trocar cannula.

10. The liquid marinade and seasoning injector assembly recited in claim 1, wherein said container port seal is comprised of a puncturable impermeable lining positioned within said container neck whereby said container port is sealed.

11. The liquid marinade and seasoning injector assembly recited in claim 10, wherein said injection needle is further comprised of a trocar cannula in fluid communication with said injection needle wherein said trocar cannula is configured to puncture said a puncturable impermeable lining within said container port.

12. The liquid marinade and seasoning injector assembly recited in claim 11, further comprising a threaded hub supporting said radially extending flange, said injection needle, and said trocar cannula.

13. A liquid marinade and seasoning injector comprising:
(a) a container containing a quantity of liquid seasoning, said container having a compressible outer surface, a container neck configured to create a seasoning port, and a puncturable seal closing said seasoning port;
(b) a container cap attached to said compressible container neck at said seasoning port, said container cap having a plurality of interior threads; and
(c) an injection needle assembly, said injection needle assembly comprising a tubular needle hub having a tubular needle in fluid communication with a pointed trocar tube and a radially extending flange, said tubular needle hub having exterior threads corresponding to said interior threads on said seasoning port.

14. The liquid marinade and seasoning injector recited in claim 13, wherein said injection needle assembly is threadedly attachable to said container cap whereby said puncturable seal is punctured by said pointed trocar tube.

15. The liquid marinade and seasoning injector recited in claim 14, wherein said puncturable seal is positioned within said container cap.

16. The liquid marinade and seasoning injector recited in claim 15, wherein said injection needle assembly is removably attachable to said compressible outer surface of said compressible container.

17. The liquid marinade and seasoning injector recited in claim 14, wherein said puncturable seal is positioned within said container neck.

18. The liquid marinade and seasoning injector recited in claim 17, wherein said injection needle assembly is removably attachable to said compressible outer surface of said compressible container.

19. A method for injecting liquid marinade and seasoning into a food product, comprising the steps of:
a. providing a compressible container having a seasoning port, a cap having a plurality of interior attachment threads, and a penetrable seal sealing said seasoning port;
b. providing a quantity of liquid marinade and seasoning within said compressible container;
c. providing an injection needle assembly, said injection needle assembly comprising:
i. a tubular needle hub, said tubular needle hub having a radially extending flange;
ii. a tubular needle in fluid communication with said tubular needle hub;
iii. a pointed trocar tube in fluid communication with said tubular needle hub and said tubular needle; and
iv. a plurality of exterior attachment threads on said tubular needle hub, said exterior attachment threads corresponding with said interior attachment threads on said seasoning port;
d. threadedly engaging said exterior threads on said injection needle hub with said interior threads of said container cap whereby said trocar tube of said injection needle assembly punctures said penetrable seal sealing said seasoning port;
e. providing a food product;
f. inserting said tubular needle of said injection needle assembly into said food product; and
g. compressing said compressible container thereby injecting said liquid marinade and seasoning from said compressible container to flow through said tubular needle into said food product.

20. (canceled)
